(19) United States
(12) Patent Application Publication
(10) Pub. No.: US 2005/0264373 A1
(43) Pub. Date: Dec. 1, 2005

(54) Switching matrix and method for distinction of a connecting line

(75) Inventor: Yoshiyuki Bessho, Tokyo (JP)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: Agilent Technologies, Inc

(21) Appl. No.: 11/096,378

(22) Filed: Apr. 1, 2005

(30) Foreign Application Priority Data
May 26, 2004 (JP) 2004156121

(51) Int. Cl. H01P 1/10

(52) U.S. Cl. 333/101; 333/105

(57) ABSTRACT

A switching matrix that comprises a plurality of input ports; a plurality of output ports; a switch array for connecting each of the input ports with the respective output port; a current source; a first switch for connecting the switch array to the current source; a voltage application means for applying a predetermined voltage; a second switch for connecting the switch array to the voltage application device; a measurement device for measuring the voltage of the current source; and a differentiating device for distinguishing the input port to which a shared signal line is connected based on the results of the measurement.

### FIELD OF THE INVENTION

The present invention relates to a switching matrix and in particular, relates to a switching matrix to which a shared signal line is connected, and a method for distinction of a connecting line.

### DISCUSSION OF THE BACKGROUND ART

When a device under test is to be measured by a measuring instrument, it is necessary to change the connection between the device under test and the measuring instrument in accordance with the subject of measurement and the measured physical quantity. A connection is changed by changing the wiring of the cable connected to the device under test and the measuring instrument, but because the number of cables also increases when there is an increase in points measured on the device under test and the number of measuring instruments, changing the wiring becomes a very complicated process. Moreover, when the same step for changing the wiring is repeated as is the case when a plurality of measurements are repeated for each measurement point, or vice versa, when the same measurement is repeated on the output from a plurality of measurement points, the time needed for measurements as a whole can be dramatically reduced by curtailing the time necessary to change the wiring.

The switching matrix wherein signal lines from a plurality of input ports and signal lines from a plurality of output ports intersect at right angles in matrix form and switches are set up at each intersection point is a device for simplifying this change of wiring. The switching matrix can output signals from the input port connected to an intersection point in question to the output port connected to the intersection point in question by turning on the switch at that intersection point.

However, when the signals transmitted between the device under test and the measuring instrument are very small signals, or when signals under test having many effective decimal places and requiring precise measurements are transmitted, transmission signals, guard signals, and ground signals are often transmitted by a coaxial cable in order to control the effect of noise from an outside source and loss due to leakage current during transmission.

A cross-section of the typical axial cable is shown in FIG. 3. FIG. 3 (a) is a coaxial cable called a Triax cable 30, and is used for unidirectional signal transmission wherein the signals are transmitted from the device under test to the measuring instrument or in the opposite direction. Triax cable 30 comprises a core conductor 31 for transmitting the transmission signals, a guard conductor 34 for transmitting the guard signals, and a shield conductor 36 for transmitting ground signals, which are all disposed on the same axis, with the conductors being separated by insulators 33 and 35 and the surface being covered with an insulator 37.

On the other hand, FIG. 3 (b) is a cable for cases where there are two transmission signals, and is called a Kelvin cable 40. Kelvin cable 40 is primarily used for two-directional transmission wherein pre-determined signals from a measuring instrument (force signals) are applied to a device under test and response signals (sense signals) from the device under test are transmitted to the measuring instrument. The structure of Kelvin cable 40 is the same as Triax cable 30 except for the fact that there are two core conductors, a core conductor 41 for transmitting force signals and a core conductor 42 for transmitting sense signals. That is, the cable has a structure wherein a guard conductor 44 and a shield conductor 46 are disposed on the same axis as the core conductor 41 such that core conductors 41 and 42 are covered, the conductors are separated by insulators 43 and 45, and the surface is covered by an insulator 47.

A Kelvin cable is functionally the same as two sets of Triax cables, but electrically it is characterized in that the capacitance between the core conductors and the guard conductor is half that of the Triax cable. This capacitance is substantially restricted in the case of many measuring instruments and in order to satisfy this restriction, a Kelvin cable must be used to provide a Kelvin connection.

The switching matrix that switches the connection between the device under test and the measuring instrument must be capable of connecting either of two cables, Triax cable 30 or Kelvin cable 40. However, when the switching matrix has 2 types of input ports, an input port for Triax cable 30 and an input port for Kelvin cable 40, there is an increase in the number of unused input ports; therefore, the efficiency with which the ports are used deteriorates and the device becomes larger. Consequently, the method is used whereby only the input and output ports for Triax cable 30 are disposed in the switching matrix and Kelvin cable 40 is connected by inputting and outputting using two ports, as shown in FIG. 4.

In FIG. 4, core conductor 41 for transmitting force signals, guard conductor 44 for transmitting guard signals, and shield conductor 46 for transmitting ground signals are connected to a signal terminal 103, a guard terminal 102, and a ground terminal 101 of an input port 100, respectively. Moreover, core conductor 42 for transmitting sense signals, guard conductor 44 for transmitting guard signals, and shield conductor 46 for transmitting ground signals are connected to a signal terminal 113, a guard terminal 112, and a ground terminal 111 of an input port 110, respectively.

Thus, it is possible to efficiently use two ports of a switching matrix by connecting a Kelvin cable, but two ports must be set up in order to switch between the input and output ports of one Kelvin cable, complicating the switching procedure. Therefore, there is a need for a method for distinguishing the type of cable connected to an input port when the power source of a switching matrix is turned on or when a cable connection is changed. This is because if the type of connected cable is known, two ports can be set up at one time and the user can easily set the switching matrix. In this regard, the method has also been considered wherein a connecting cable to which a differentiating apparatus is connected is used for auto-differentiating, but there is a problem in that there is no interchangeability with conventional connected cables.

### SUMMARY OF THE INVENTION

The above-mentioned problem can be solved by a switching matrix that is characterized in that it comprises a plurality of input ports; a plurality of output ports; a switch array for connecting each of the input ports with the respective output port; a current source; a first switch for connecting the switch array with the current source; voltage application means for applying a pre-determined voltage; a second switch for connecting the switch array with the voltage application means; a measurement means for measuring the voltage of the current source; and a differentiating means for distinguishing the input port to which a shared signal line is connected based on the results of the measurement.

More specifically, a pre-determined voltage is applied to a guard terminal of one port, a current source is connected to a guard terminal of the other port, and the voltage of the terminal to which the current source has been connected is measured in order to distinguish the type of cable. The guard signals up to the ports to which a Kelvin cable has been connected have a shared signal line; therefore, the measured potential is approximately the same as the applied voltage. In contrast to this, when a Triax cable is connected to one or both of two ports, or signals from a different Kelvin cable are applied, the measured potential is not the same as the applied voltage. It is possible to distinguish the combination of input ports to which the Kelvin cable has been connected by performing this type of distinguishing procedure for each port.

Input ports to which a shared signal line has been connected can be distinguished and the efficiency of the switching procedure is improved.

### BRIEF DESCRIPTION OF THE DRAWINGS

FIG. 1 is an enlarged view of the switching part of the embodiment.

FIG. 2 is an enlarged view of the relay switch of the embodiment.

FIG. 3 is a diagram of the cable.

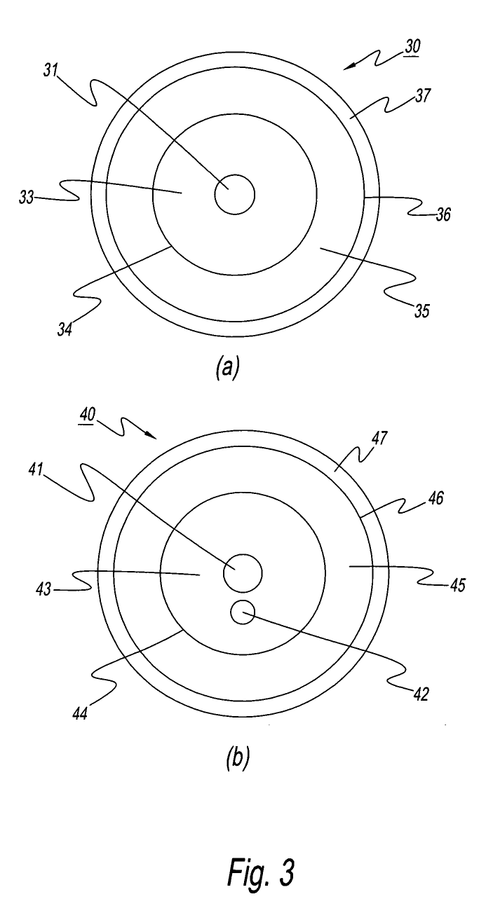

FIG. 4 is a diagram showing the connection between the Kelvin cable and the switching matrix.

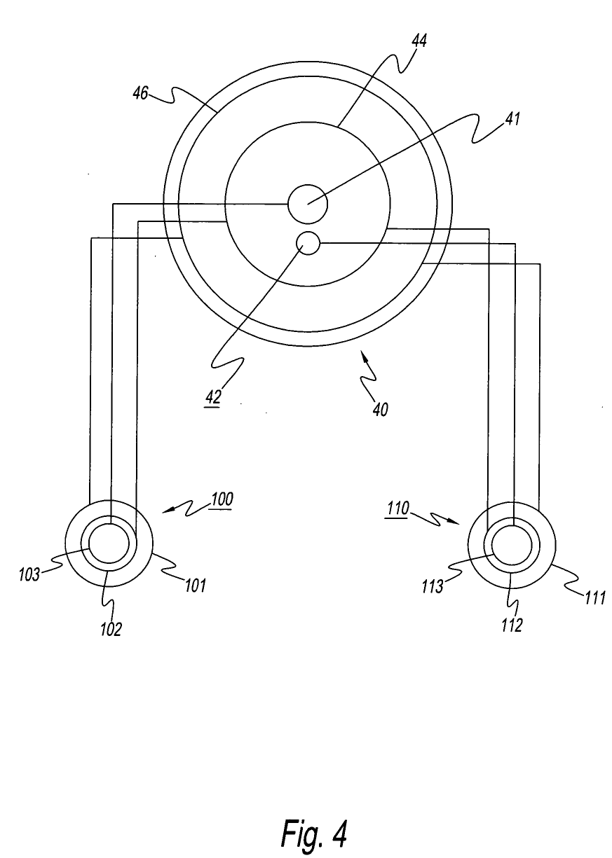

FIG. 5 is a diagram showing the structure of the switching matrix related to the present invention.

FIG. 6 is a diagram showing the flow chart for the distinguishing method of the present invention.

### DETAILED DESCRIPTION OF THE PREFERRED EMBODIMENT

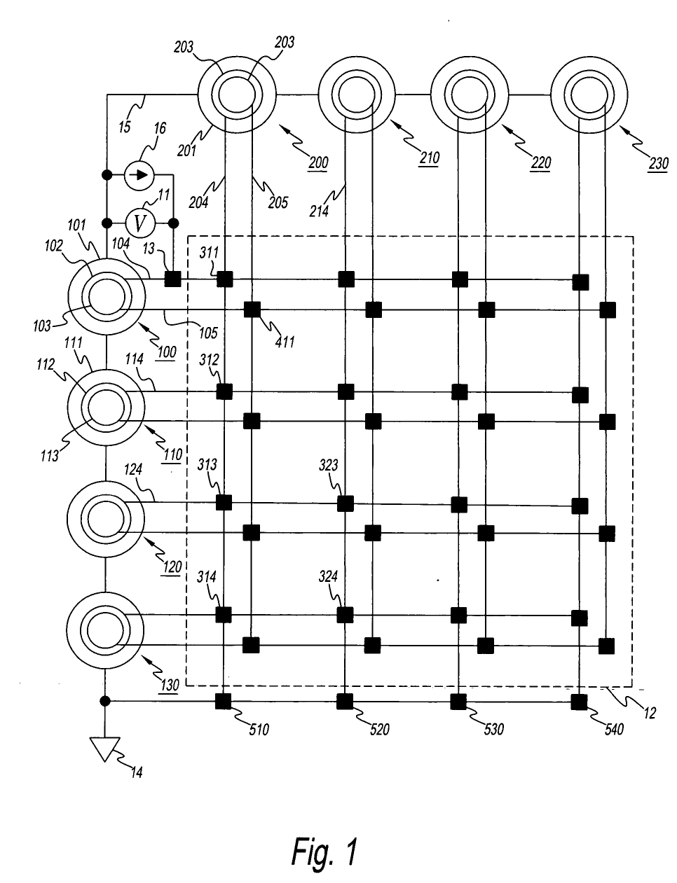

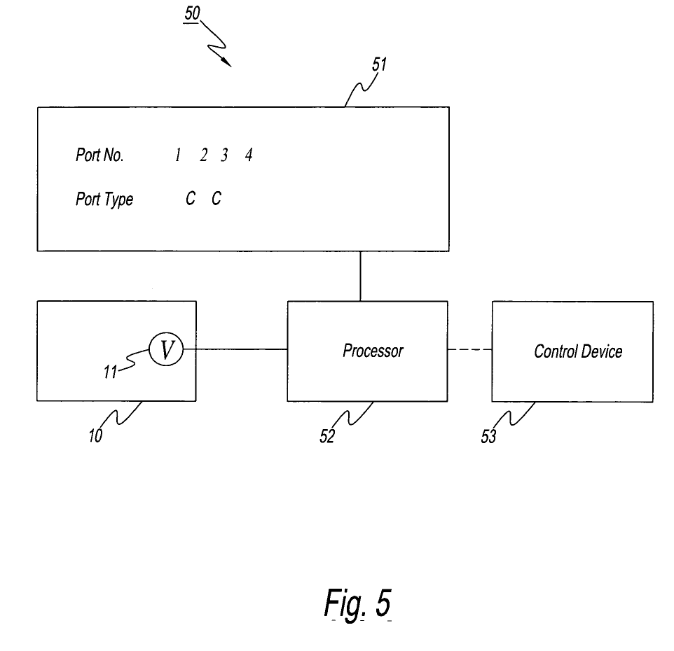

A block diagram of a switching matrix 50 relating to the present invention is shown in FIG. 5 and a circuit diagram of a switching part 10 is shown in FIG. 1.

Switching matrix 50 comprises switching part 10, a processor 52 (differentiating means) connected to voltmeter 11 of switching part 10, and a display 51 (display means) connected to processor 52. Switching part 10 further comprises a plurality of input-output ports (100, 200, etc.), a switch array 12 connected to each input-output port, a current source 16, a switch 13 for connecting/disconnecting switch array 12 and the current source 16, voltmeter 11 (measurement means) connected to both terminals of current source 16, and switches (510, 520, etc.) for connecting/disconnecting switch array 12 and a ground terminal 14 (voltage application means). Processor 52 is capable of radio or wireless communication between the measuring instrument and a computer or other type of external control device 53 using GP-IB, LAN, and the like.

Switching matrix 50 has four input ports 100, 110, 120, and 130, and four output ports, 200, 210, 220, and 230. The number of input ports and output ports is not limited to four as in the present embodiment as long as there is a plurality of both input ports and output ports. Input port 100 comprises three terminals, a ground terminal 101, a guard terminal 102, and a signal terminal 103, disposed coaxially from the outside. Ground terminal 101 is connected to a ground line 15 and is usually grounded. Guard terminal 102 is the terminal that inputs guard signals and is connected to a guard signal line 104. Signal terminal 103 is the terminal that inputs the signal source sense signals and is connected to a signal line 105. The structure of the other input ports 110, 120, and 130 as well as output ports 200, 210, 220, and 230 is the same as the structure of input port 100.

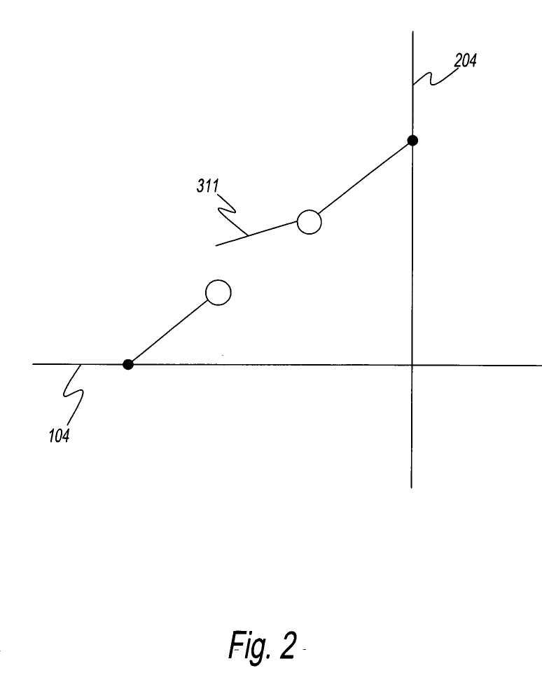

The signal lines from the input ports (104, 105, etc.) and the signal lines from the output ports (204, 205, etc.) intersect at right angles in matrix form at switch array 12, and relay switches (311, 411, etc.) are disposed at each intersection point. As shown in FIG. 2, relay switch 311 is connected to signal line 104 from the input ports and its other end is connected to signal line 204 from the output ports. By turning the switch on, signals that have been input from guard terminal 102 of input port 100 are transmitted to guard terminal 202 of output port 200. The other relay switches (312, 411, etc.) perform the same act. Although relay switches are used in the present embodiment, the switches (311, 411, etc.) are not limited to relay switches, and semiconductor switches, or other types of switches can also be used.

Moreover, the 100-microampere constant-current source 16 and voltmeter 11 are connected between signal line 104 and ground line 15 with the relay switch 13 (first switch) in between. The connection of relay switch 13 is the same as for relay switch 311 shown in FIG. 2. Constant-current source 16 adjusts the output voltage such that the output current is 100 microamperes, but if a 100 microampere current is not flowing even though 12 V are applied, the output of 12 V will be retained. Voltmeter 11 is made from a comparator to which signal line 104 and a 5 V constant-voltage source (reference voltage) have been connected and it evaluates whether the voltage of signal line 104 is larger or smaller than the 5 V reference voltage. It should be noted that a relay tester for evaluating whether or not the relay switches are capable of performing the desired control can be used for voltmeter 11. Moreover, voltmeter 11 is not necessarily made from a comparator, and a physical quantity (voltage) can be measured using a A/D converter, and similar means.

Signal line 204 connected to guard terminal 202 of output port 200 is connected to relay switch 510 and when switch 510 is turned on, [signal line 204] is connected to signal line 202 and ground terminal 14. The connection of switch 510 is the same as for switch 311 shown in FIG. 2. The signal lines connected to the guard terminals of the other output ports 210, 220, and 230 are also connected to ground terminal 14 with relay switches 520, 530, and 540 in between, respectively.

Processor 52 has the function of distinguishing whether or not the cable connected to the input port is a Kelvin cable, based on the output from voltmeter 11 (differentiating means) and also has the function of controlling the overall operation of switching matrix 50. Moreover, display 51 is a liquid crystal display and displays the No. of the input port and the type of cable connected to this port. Ports No. 1, No. 2, No. 3, and No. 4 show input ports 100, 110, 120, and 130, respectively.

Moreover, when control device 53 is connected, processor 52 communicates with said control device 53 and controls switching matrix 50. For instance, the act of identifying the port to which a Kelvin cable is connected is started in response to an input port differentiation command from the control device 53 and the port No. is output to control device 53. Moreover, when an error is produced during processing, the error information as well as the status information are output.

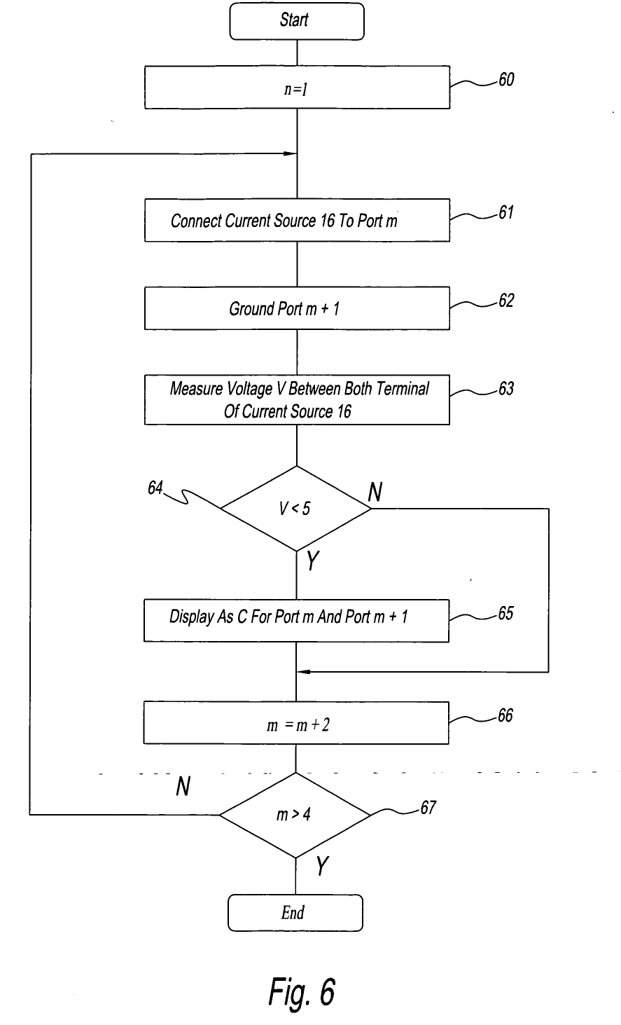

The distinguishing operation of switching matrix 50 relating to the present invention will now be described while referring to the flow chart in FIG. 6. Switching matrix 50 performs the distinguishing operation when the power source is turned on or when there is a “couple port” distinction command from control device 53.

First, a variable n showing the No. of the port that is the subject of this distinction is initialized at 1 (Step 60). Whether a Kelvin cable is connected to port 1 (input port 100) or port 2 (input port 110) is identified when n=1.

Switch 13 is turned on and current source 16 is connected to guard signal line 104 of port 1 (step 61). At the same time, switches 312 and 510 are turned on and guard signal line 114 of port 2 is grounded (step 62). In this state, the voltage V of both terminals of current source 16 is measured by voltmeter 11 (step 63) and its magnitude is compared with the reference voltage (step 64).

When signals from the same Kelvin cable are applied to ports 1 and 2, the guard signal line becomes the shared signal line; therefore, the voltage of signal line 104 of port 1 becomes ground potential and the measurement result of voltmeter 11 is smaller than the reference potential. When the voltage of signal line 104 is lower than the reference potential, process 52 displays “C” (“couple port”) in the port column corresponding to ports 1 and 2 of display 51 (step 65). On the other hand, if the same Kelvin cable is not connected to the two ports, constant-current source 11 cannot produce a 100-microampere current, no matter how much the voltage is raised; therefore, voltage V becomes the maximum voltage of 12 V, exceeding the reference potential. Nothing is displayed on display 51 when voltage V is higher than the reference voltage and processor 52 proceeds to the next process.

When the distinguishing operation is due to a request from control device 53, this is displayed on display 51 and information on the connection with external control device 53 is transmitted through the communications circuit. A Kelvin cable is used with adjacent ports according to the specifications of switching matrix 50 of the present embodiment, and processor 52 outputs only the port No. which is smaller (1). The Nos. of all of the ports to which a Kelvin cable is connected (1 and 2 in the connection example of the present embodiment) can also be output in accordance with the specifications of control device 53.

The reason for measuring the voltage by comparison with a reference potential will now be briefly explained. Theoretically, whether or not voltage V of current source 16 and the voltage of the voltage application means (applies ground potential to ground terminal 14 in the present embodiment) are the same potential should be identified in order to identify the shared signal line, and a reference potential is not necessary. However, voltage V and the voltage of the voltage application means actually are not necessarily the same potential because of the voltage drop that occurs due to the circuit resistance inside switching matrix 50 and the resistance of the cable. Therefore, the effect of this voltage drop can be eliminated by a method whereby a comparison is made between voltage V and the reference potential. Theoretically, voltage V should be 0 V when input signals from the same Kelvin cable are applied to port 1 and port 2 and should be 12 V when different cables are connected in the present embodiment, but an error is not identified when the voltages are 4 V and 8 V due to the effect of the voltage drop.

Return again to the description of the distinguishing step. The number 2 is added to variable n to obtain n=3 (step 66). n<4; therefore, it is possible to identify whether or not the same Kelvin cable is connected to ports 3 and 4 by repeating the process from steps 61 to 66 (step 67). Current source 16 is connected to guard signal line 124 of port 3 by turning on switches 13, 311, and 313 in step 61 of the second order. Moreover, guard signal line 134 of port 4 is grounded by turning on switches 324 and 520. When the differentiation of ports 3 and 4 is completed, n=5 in step 66 and the distinguishing operation is completed.

In addition, it is merely assumed that a Kelvin cable is connected using the combination of ports 1 and 2 or ports 3 and 4 of switching matrix 50 of the present embodiment; therefore, each combination of ports is evaluated. It is possible to identify the port type by setting the increase in the variable n at 1 in step 66 and repeating steps 61 through 66 three times (differentiation of ports 1 and 2, differentiation of ports 2 and 3, differentiation of ports 3 and 4). Furthermore, when it is assumed that a Kelvin cable is connected to ports that are not adjacent (for instance, ports 1 and 3), all combinations of ports (ports 1 and 2, ports 1 and 3, ports 1 and 4, ports 2 and 3, ports 2 and 4, ports 3 and 4) can be differentiated.

The technical concept relating to the present invention has been described in detail while referring to a specific embodiment, but persons skilled in the art of the present invention can obviously make various changes and modifications without deviating from the gist and scope of the claims. For instance, a method of distinguishing a shared signal line was described taking as an example the differentiation of a Kelvin cable connection in the present embodiment, but this technology has various uses as a method for generally distinguishing ports to which shared signal lines are connected.

For instance, it is possible to distinguish which port is connected from the same device under test or measurement instrument by applying the ground voltage of the device under test or the measurement instrument to the guard signal line. Moreover, the voltage applied by the voltage application means is not necessarily ground potential and any voltage can be applied. In this case, processor 52 can distinguish whether a shared signal line is connected by determining whether or not voltage Va applied by the voltage application means virtually matches voltage Vb measured by voltmeter 11. Of course, Va and Vb are not directly compared when it is assumed that there will be an effect due to voltage drop, and similar considerations during differentiation, as in the above-mentioned example. An error in differentiation can be prevented by distinguishing whether or not a shared signal line is connected based on comparing the magnitude of Vb and a voltage Vc intermediate between Va and Vb.

The current source, the voltage source, and other components that are used in the present invention are not necessarily special equipment for use in a switching matrix in order to differentiate cables. It is clear that the same functions can be realized when all or some of these components are external to the matrix.

1. A switching matrix which comprises:
a plurality of input ports;
a plurality of output ports;
a switch array for connecting each of the input ports with the respective output port;
a current source;
a first switch for connecting the switch array with the current source;
a voltage application means for applying a pre-determined voltage;
a second switch for connecting the switch array with the voltage application means;
a measurement means for measuring the voltage of the current source; and
a differentiating means for distinguishing the input port to which a shared signal line is connected based on the results of the measurements.

2. The switching matrix according to claim 1, further comprising a display for displaying the results from the differentiating means.

3. The switching matrix according to claim 1, wherein each one of the plurality of input ports comprises a signal terminal, a guard terminal, and a ground terminal, wherein a signal line connected to said guard terminal is said shared signal line.

4. The switching matrix according to claim 1, wherein said differentiating means has the function of distinguishing one set of input ports to which a Kelvin cable has been connected.

5. The switching matrix according to claim 1, wherein said differentiating means operates when the power source of the switching matrix is turned on.

6. The switching matrix according to claim 1, wherein said switching matrix operates in accordance with requests from a control means connected to the differentiating means.

7. A method for distinguishing the input port to which a shared signal line has been connected, said method comprising the steps of:
connecting a current source to a first input port;
setting a second input port to a predetermined potential;
measuring a voltage of said first input port; and
differentiating said input port to which the shared signal line is connected based on the results of the measurements.

8. The method according to claim 7, wherein said first input port and said second input port are adjacent input ports.

9. The method according to claim 7, wherein said differentiating step occurs whether the shared signal line is connected to the first input port or the second input port based on comparing the magnitude of a predetermined reference potential and the voltage of the first input port.

10. The method according to claim 7, wherein said predetermined potential is ground potential.

11. The method according to claim 7, further comprising a step of displaying a port number of the input port connected to the shared signal line.

12. The method according to claim 7, further comprising a step of transmitting the port numbers of the input ports to which the shared signal line is connected to the outside by means of a communications circuit.
